(19) United States
(12) Patent Application Publication
(10) Pub. No.: US 2026/0087300 A1
(43) Pub. Date: Mar. 26, 2026

(54) ELECTRONIC HARD TAG FOR APPLICATION ON A PRODUCT AND PRODUCT COMPRISING THE ELECTRONIC HARD TAG

(71) Applicant: AUTHENA AG, Zug (CH)

(72) Inventors: Matteo Panzavolta, Rüschlikon (CH); Dejan Milenovic, Horgen (CH); Milosz Tokarski, Wroclaw (PL)

(21) Appl. No.: 19/108,816

(22) PCT Filed: Sep. 4, 2023
(86) PCT No.: PCT/EP2023/074144

§ 371 Date: Mar. 5, 2025

(30) Foreign Application Priority Data
Sep. 8, 2022 (CH) CH001053/2022

(51) Int. Cl. G06K 19/077

(52) U.S. Cl. CPC G06K 19/0776

(57) ABSTRACT

The disclosure relates to an electronic hard tag for application on a product and to a packaging or a product comprising the electronic hard tag, the electronic hard tag comprising a radio frequency identification circuit and a housing, wherein the electronic hard tag further comprises a first circuit adhesion layer arranged between the housing and the radio frequency identification circuit and configured to attach the radio frequency identification circuit to the housing, and a product adhesion layer, arranged on a product side of the housing and on the frequency identification circuit, and configured to attach the housing and the radio frequency identification circuit to the product.

### FIELD OF THE DISCLOSURE

The present disclosure relates to an electronic hard tag for application on a product, to a product comprising the electronic hard tag and to a packaging for a product comprising the electronic hard tag. Specifically, the present disclosure relates to an electronic hard tag for application on a product comprising a radio frequency identification circuit and a housing.

### BACKGROUND OF THE DISCLOSURE

Known tags are attached to a product container or products themselves, for example by a tie, or by using an adhesive (i.e. a tag in the form of a label). Simple tags are used to record information about the product, for example a product name, product manufacturer, instructions related to the use of the product, certifications related to the product, etc. Tags can also feature a printed machine-readable visual code, for example in the form of a barcode or a QR code, which enables a barcode scanner, for example, to identify the product. These types of tags are typically made from die-cut plastics, papers, metals, or other materials and have information printed on them. Such tags are in everyday use, from food items to cardboard shipping boxes.

More recent developments in the field of tags include the use of electronic circuitry, in particular RFID circuitry, to enable a product scanner to read digital information from the tag electronically. RFID tags have some advantages over machine-readable visual code, for example, they do not require a line of sight with a scanner, and they are able to store more data. Such tags are gaining widespread use, for example in the airline industry, where luggage is typically tracked using an adhesive tag containing an RFID circuit.

Tamper-evident labels are also known which have one or more indicators or barriers to entry which, if breached or missing, provide visible evidence that tampering has occurred. Items such as over-the-counter drugs and packaging materials use these types of labels on their products. Tamper-evident labels are attached to the product or container in such a way as to prevent access to the product or container without leaving visible evidence. For example, tamper-evident labels feature slits or weakened portions, or particular types of adhesive, such that attempted removal of the tamper-evident label results in visible damage.

Hard tags are also known and are used for products where difficult conditions or surroundings may harm the tag. Such harsh conditions are for example possible impacts, shocks or specific chemical conditions, which might affect the functionality of the tag. To protect the hard tag, in particular to protect the electronics inside the hard tag a closed and robust housing is conventionally used, which completely surrounds the electronics placed inside. Conventionally, these hard tags are, for example, glued onto a product. It is in particular easy to remove such conventional hard tags from the product by levering the edge of the hard tag until it is removed from the product. Conventionally, it is possible to remove the hard tag without destroying it from the product or from the packaging of the product. For example, someone might lever the conventional hard tag from a packaging, removes the product out of the packaging, closes the packaging and places the conventional hard tag back on the packaging, without leaving a trace.

EP 3 217 326 A1 relates to a smart tag for attachment to an object. The smart tag comprises an electronic system for contactless communication, a support to which at least part of the electronic system is fixed and destruction means configured to act on at least one element of the electronic system, when the smart tag is removed from said object, to demolish said at least one element of the electronic system. The destruction means includes a demolisher movably mounted to pass through said support from a first position on one side of the support to a second position on the other side of the support. Two different adhesion layers providing different functionalities are not disclosed in this document.

US 2009/314842 A1 relates to a radio-frequency identification device including embedded in an envelope a substrate on one face of which an antenna is produced and a chip connected to the antenna is positioned, a potting locally covering the substrate face level with the chip, an intermediate layer made of a magnetic superconductor material placed against the substrate on the antenna side, the intermediate layer having dimensions greater than those of the antenna so as to be able to cover the antenna and having a cavity arranged so that the potting and the chip can be approximately completely housed therein. This document does also not disclose two different adhesion layers providing different functionalities.

EP 3 005 240 A1 relates to a frangible RFID tag including a substrate having at least one weakened area, an RFID chip and an antenna. The RFID chip and the antenna are located on the substrate and the antenna is electrically connected to the RFID chip. The RFID tag also includes a plurality of adhesive areas applied to the underside of the substrate. The adhesive areas allow the RFID tag to be secured to an object. This document does not even disclose a hard tag or hard housing, which is connected to the product directly via an adhesive.

US 2012/187197 A1 relates to an embedded RFID (radio frequency identification) tags for objects or containers. The RFID tags are embedded within recesses within the outer surfaces of objects or containers, such as within a metal valve flange for a metal container. The RFID tags can also be shaped and configured to fit within recesses so that the top surfaces of the RFID tags match the outer surfaces of the objects or containers. This document does not even disclose an adhesive at all.

US 2022/277183 A1 relates to a radio frequency identification (RFID) device configured to be coupled to a surface of an object. The RFID device may include a housing having a first casing and a second casing. The RFID device may also include an RFID tag disposed between the first casing and the second casing. The RFID tag may comprises an antenna and an integrated circuit coupled to the antenna. Further, the RFID device may include a first break-line defined in the first casing and extending between an inner edge and an outer edge of the first casing. The first casing may be breakable along the first break-line. In addition, the RFID device may include a second break-line defined in the second casing and extending between an inner edge and an outer edge of the second casing. No adhesive layer of this document attaches the housing and the RFID device to the product.

### SUMMARY OF THE DISCLOSURE

It is an object of the present disclosure to provide an electronic hard tag for application on a product, a product with the electronic hard tag and a packaging with the electronic hard tag. In particular, it is an object of the present disclosure to provide an electronic hard tag for application on a product, a product with the electronic hard tag and a packaging with the electronic hard tag, which do not have at least some of the disadvantages of the prior art. In particular, it is an object of the present disclosure to provide an electronic hard tag for application on a product, which will not be responsive after an attempted removal from a product or from a packaging of the product.

According to the present disclosure, these objects are addressed by the features of the independent claims. In addition, further advantageous embodiments follow from the dependent claims and the description.

According to the present disclosure, an electronic hard tag for application on a product is specified. The electronic hard tag typically comprises a radio frequency identification circuit and a housing. The housing typically encloses partially the radio identification circuit. The electronic hard tag further comprises a first circuit adhesion layer, arranged between the housing and the radio frequency identification circuit. The first circuit adhesion layer is configured to attach the radio frequency identification circuit to the housing. The electronic hard tag further typically comprises a product adhesion layer, arranged on a product side of the housing and on the frequency identification circuit, and configured to attach the housing and the radio frequency identification circuit to the product. The product side of the housing is the side, which is configured to be attached to the product or a packaging of the product. According to the present disclosure, the housing of the electronic hard tag protects the radio frequency identification circuit from possible mechanical damage. Further, the radio frequency identification circuit is attached via the first circuit adhesion layer on the housing and via the product adhesion layer on the product. An attempted removal of the housing, by for example, levering the housing from the product, could destroy the radio frequency identification circuit, because some parts of it may remain on the product and some parts may be removed. The electronic hard tag according to the present disclosure provides therefore an anti-counterfeit protection.

The electronic hard tag according to the present disclosure advantageously will not be responsive after an attempted removal from the product, because the likelihood that the radio frequency identification circuit is destroyed, due to the attempted removal, is very high. The adhesion layers are, according to an embodiment, thin liquid adhesive films or coatings. Radio-frequency identification (RFID) uses electromagnetic fields to automatically identify and track tags attached to objects. An RFID system consists typically of a tiny radio transponder, a radio receiver and transmitter. When triggered by an electromagnetic interrogation pulse from a nearby RFID reader device, the tag transmits digital data, usually an identifying inventory number, back to the reader. This number can be used to track inventory goods or to transmit data from the product to the RFID reader device like a smartphone.

The radio frequency identification circuit is for example implemented as an inlay, which comprises the electronics including the antenna of the radio frequency identification circuit. An RFID Inlay is for example just the RFID Chip (IC), Antenna and Substrate, typically on a film face.

In an embodiment, the electronic hard tag is a passive tag, which is powered by energy from the RFID reader's interrogating radio waves. In another embodiment, the electronic hard tag is an active tag, which is powered by a battery and thus can be read at a greater range from the RFID reader, for example up to ten meters or even up to hundreds of meters.

In an embodiment, the electronic hard tag further comprises a RFID cover, arranged between the product adhesion layer and the radio frequency identification circuit, wherein the product adhesion layer is configured to attach the RFID cover to the product. According to this embodiment, the product adhesion layer is not directly in contact with the radio frequency identification circuit, but indirect via the RFID cover, which is in contact with the product adhesion layer. In other words, the product adhesion layer is arranged between the product and the RFID cover, when the electronic hard tag is applied on a product. According to this embodiment, the electronic hard tag further comprises a second circuit adhesion layer, arranged between the RFID cover and the radio frequency identification circuit, wherein the second circuit adhesion layer is configured to attach the radio frequency identification circuit to the RFID cover. In other words, the radio frequency identification circuit is attached to the housing via the first circuit adhesion layer and to the RFID cover via the second circuit adhesion layer. According to this embodiment, the RFID cover could be considered as part of the overall housing of the electronic hard tag, which might protect the radio frequency identification circuit from damages/chemicals, which might come from the product side. The RFID cover additionally protects the underside of the electronic hard tag during transportation and handling of the electronic hard tag in particular prior to be applied on the product.

In an embodiment, the radio frequency identification circuit comprises an antenna, which is at least partially attached via the first circuit adhesion layer to the housing, wherein the antenna is further configured to be at least partially attached to the product via the product adhesion layer, or wherein the antenna is at least partially attached via the second circuit adhesion layer to the RFID cover. In other words, the relatively fragile antenna of the radio frequency identification circuit is in one embodiment attached/glued to the housing via the first circuit adhesion layer and to the product (when applied to the product) via the product adhesion layer. In the other embodiment, the relative fragile antenna is attached to the housing via the first circuit adhesion layer and is attached/glued to the RFID cover via the second circuit adhesion layer. In both embodiments, an attempted removal of the electronic hard tag would induce shear forces on the antenna, because an attempted removal would lever the housing from the antenna, which would probably destroy the antenna. Attaching the relatively fragile antenna via the respective adhesion layers to the housing and product or RFID cover advantageously increases the probability that an attempted removal of the electronic hard tag from the product would destroy the antenna of the electronic hard tag, which would destroy the readability of the electronic hard tag.

In an embodiment, the housing has a cylindrical outer shape and comprises a cavity, which extends from the product side of the housing into the housing until a cavity bottom, and wherein the first circuit adhesion layer attaches the radio frequency identification circuit to the cavity bottom. The cylindrical outer shape is, for example defined by a planar surface, having a specific shape, like a rectangular shape, which is vertically extended, thereby forming a rectangular cylindrical shape. The cylindrical outer shape is the outer contour of the electronic hard tag. The cavity or the depression is arranged on the product side of the housing and extends into the housing thereby forming space for the radio frequency identification circuit and the RFID cover in the housing. According to this embodiment, the electronic hard tag is advantageously compact and the electronics of the electronic tag are advantageously protected inside the housing.

In an embodiment, the housing has an outer circular cylindrical shape, and wherein the cavity has a circular cylindrical shape and extends coaxially with respect to circular cylindrical shape of the housing. The circular cylindrical shape is advantageously simple to manufacture. Further, the coaxial arrangement of the housing and the cavity are advantageously simple to manufacture and create a symmetric compact electronic hard tag.

In an embodiment, the RFID cover has a cylindrical shape and is arranged within the cavity of the housing, and wherein the product axial end of the RFID cover is attached to the product adhesion layer, and wherein the second circuit adhesion layer attaches the radio frequency identification circuit to the axial end of the RFID cover arranged opposite with respect to the product axial end. The RFID cover comprises two axial ends, one is configured to be attached via the product adhesion layer to the product and the other one is attached to the radio frequency identification circuit.

In a further embodiment, the shape of the RFID cover corresponds to the shape of the cavity of the housing such that the RFID cover fits advantageously within the cavity. According to this embodiment, it is in particular possible to protect the electronics inside the cavity from penetration of fluids.

In an embodiment, the RFID cover has an outer circular cylindrical shape, and wherein the RFID cover is arranged coaxially with respect to the housing. The outer circular cylindrical shape is defined, for example, by a circular surface as base area, which is extended at a predefined height, thereby creating the circular cylindrical shape. The circular cylindrical shape is in particular simple to manufacture.

In an embodiment, the outer contour of the radio frequency identification circuit corresponds to the shape of the axial end of the RFID cover opposite to the product axial end. The radio frequency identification circuit comprising the antenna has for example a flat circular shape, in this case, the RFID cover may be designed such that the radius of the respective axial end of the RFID cover corresponds to the radius of the radio frequency identification circuit. According to this embodiment, the radio frequency identification circuit, in particular the antenna, can advantageously be attached at the RFID cover.

In an embodiment, the product axial end of the housing and the product axial end of the RFID cover are arranged coplanar with respect to each other, thereby forming a plane surface onto which the product adhesion layer is attached. With the coplanar arrangement, the electronic hard tag is advantageously attachable at the product.

In an embodiment, the product adhesion layer extends from the outer edge of the product axial end of the housing until the center point of the product axial end of the RFID cover. According to this embodiment, it is advantageously possible to apply the product adhesion layer in one production step on the electronic hard tag.

In a further embodiment, the product adhesion layer comprises a first portion, which is arranged on the housing, and a second portion, which is arranged on the RFID cover, thereby leaving a gap between the first portion on the housing and the second portion on the RFID cover. In this embodiment, the product adhesion layer is for example separately applied on the housing and on the RFID cover, which advantageously prevents that the parts of the product adhesion layer may stick together such that an attempted removal of the electronic hard tag would result in the removal of the entire electronic hard tag and not only of the housing.

In an embodiment, the product adhesion layer is configured such that an attempted removal of the housing from the product, onto which the electronic hard tag is attached, results in a separation of the housing from the product adhesion layer and wherein the circuit adhesion layer(s) is/are configured such that the attempted removal of the housing from the product results in a destruction of the frequency identification circuit. In other words, the product adhesion layer and the circuit adhesion layer are according to this embodiment, configured such with respect each other that the attempted removal of the housing from the product would destroy the radio identification circuit. The required harmonization between the different adhesive layers is for example achieved via specific material properties of the respective adhesion layers. In other words, the different adhesion layers (first, second circuit adhesion layer or the product adhesion layer) may have different material compositions for achieving the desired destruction during an attempted removal.

In an embodiment, the first circuit adhesion layer is arranged only partially between the housing and the frequency identification circuit and/or wherein the product adhesion layer is arranged only partially between the product and the radio frequency identification circuit or wherein the second circuit adhesion layer is arranged only partially between the radio frequency identification circuit and the RFID cover. For example, the product adhesion layer is arranged only partially on the antenna of the radio frequency identification circuit on the product side and the first circuit adhesion layer is arranged only partially on the antenna of the radio frequency identification circuit on the opposite side. In a further embodiment, the first circuit adhesion layer is arranged only partially on the radio frequency identification circuit, in particular on the antenna, and the second circuit adhesion layer is arranged only partially on the radio frequency identification circuit, in particular on the antenna. In a further embodiment, the surfaces of the radio frequency identification circuit which comprise partially adhesive material vary with respect to both sides (product side and opposite side). According to these embodiments, it is in particular simple to apply shear forces on the radio identification circuit in case of an attempted removal of the housing from the product, which increases the probability that the radio frequency identification circuit of the electronic hard tag will be destroyed as desired.

In an embodiment, the housing and/or the RFID cover comprise or comprises polyphenylene sulfide (PPS), acrylonitrile butadiene styrene (ABS), poly amid, for example PA66, or a combination thereof. These materials provide the required robustness and durability of the housing.

In an embodiment, the product adhesion layer, the first circuit adhesion layer and/or the second circuit adhesion layer comprises an acrylic adhesive. An acrylic adhesive (also known as methylmethacrylate, acrylate, or MMA) is a resin-based, two-part adhesive comprised of acrylic or methylacrylic polymers. They are advantageously strong and efficient in bonding multiple objects together and are very environmentally resistant, an provide therefore the required bonding properties to attach the radio frequency identification circuit to the housing, the product and/or the RFID cover respectively. The specific composition of the product adhesion layer, the first circuit adhesion layer and the second circuit adhesion layer may vary with respect to each other.

In a further aspect of the present disclosure, a packaging of a consumer product, wherein the packaging comprises an electronic hard tag as disclosed above and hereinafter is specified.

In a further aspect of the present disclosure, a consumer product comprising an electronic hard tag as disclosed above and hereinafter is specified.

It is to be understood that both the foregoing general description and the following detailed description of present embodiments are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

The present disclosure will be explained in more detail, by way of example, with reference to the drawings in which:

FIG. 1: shows a perspective view of a first embodiment of the electronic hard tag;

FIG. 2: shows a perspective view of a partial section of the first embodiment of the electronic hard tag;

FIG. 3: shows a first exploded view of the first embodiment of the electronic hard tag;

FIG. 4: shows a second exploded view of the first embodiment of the electronic hard tag;

FIG. 5: shows a second embodiment of the electronic hard tag, in particular a top view, a side view and a section view of the second embodiment;

FIG. 6: shows an exploded view of the second embodiment of the electronic hard tag;

FIG. 7: shows in the top a section view of a state of the art hard tag and on the bottom an attempted removal of this hard tag;

FIG. 8: shows in the top a section view of the electronic hard tag of the first embodiment and on the bottom an attempted removal of this electronic hard tag.

### DETAILED DESCRIPTION OF THE EMBODIMENTS

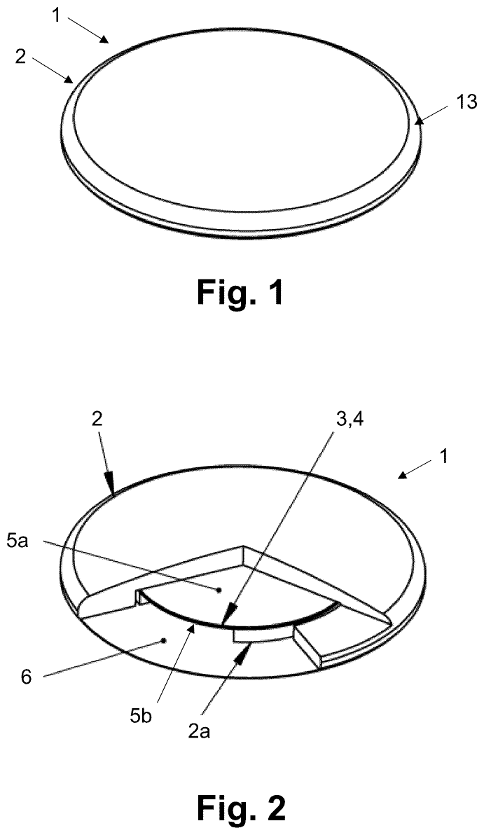

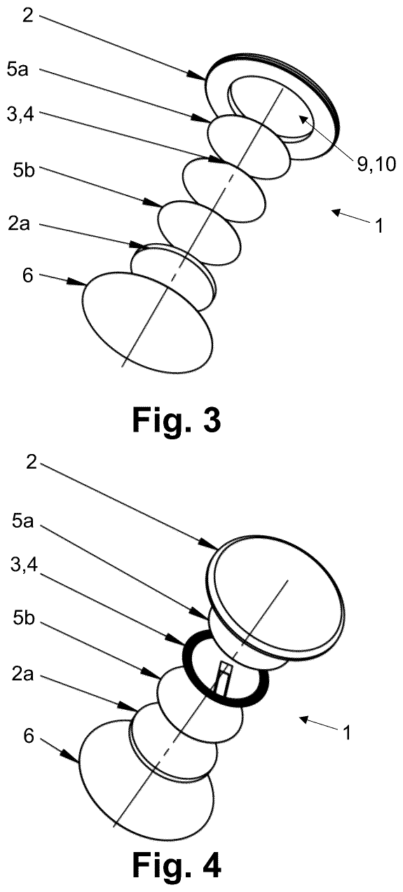

The FIGS. 1, 2, 3 and 4 show schematically an electronic hard tag 1 according to a first embodiment. FIG. 1 in particular shows a housing 2 of the electronic hard tag 1, which surrounds the interior of the electronic hard tag 1. FIG. 2 shows schematically a perspective view of the electronic hard tag 1 according to the first embodiment, wherein the perspective view comprises a partial section view. The FIGS. 3 and 4 show a first and second exploded view of the electronic hard tag 1 according to the first embodiment.

The electronic hard tag 1 according to the first embodiment has a coin like outer shape/contour. In other words, the electronic hard tag 1 has a circular cylindrical shape. The housing 2 of the electronic hard tag 1 comprises a chamfer or a rounding 13 on the top edge of the electronic hard tag 1. The electronic hard tag 1 further comprises a radio frequency identification circuit 3, which is arranged within the housing 2. The radio frequency identification circuit 3 comprises an antenna 4, which is attached/glued to the housing 2 via a first circuit adhesion layer 5a. The electronic hard tag 1 further comprises a RFID cover 2a, which is arranged between the radio frequency identification circuit 3 and a product, when the electronic hard tag 1 is applied to a product 7. The electronic hard tag 1 further comprises a product adhesion layer 6, which is configured to attach the electronic hard tag 1 to the product 7 or to a packaging 11 of the product 7. The product adhesion layer 6 contacts the housing 2 and the RFID cover 2a and is therefore configured to attach the housing 2 and the RFID cover 2a to the product 7. The RFID cover 2a is attached to the radio frequency identification circuit 3 via a second circuit adhesion layer 5b. The first circuit adhesion layer 5a and the second circuit adhesion layer 5b comprise, for example, the same adhesive. The housing 2 of the electronic hard tag 1 further comprises a cavity 9, in other words, a depression, which extends from a product side 12 of the housing 2 into the housing 2 to a cavity bottom 10 (best visible in FIG. 3). The radio frequency identification circuit 3 is attached via the first circuit adhesive layer 5a to the cavity bottom 10. The cavity 9 and the RFID cover 2a have a circular cylindrical shape and the RFID cover 2a is configured to fit into the cavity 9. The antenna 4 of the radio frequency identification circuit 3 has a flat ring shape and has the same outer diameter as the RFID cover 2a (best visible in FIG. 4). The housing 2, the antenna 4 and the RFID cover 2a are rotationally symmetric and are arranged coaxially with respect to each other.

The first circuit adhesive layer 5a and the second circuit adhesive layer 5b contact according to this embodiment the entire radio frequency identification circuit 3 on both axial sides. In another embodiment, the circuit adhesive layers 5a, 5b may be arranged only partially on the radio frequency identification circuit 3. According to the embodiment, as best visible in the FIGS. 3 and 4, the product adhesive layer 6 extends from the outer edge of the housing 2 until the center point of the RFID cover 2a. In other words, the product adhesive layer 6 covers the entire product side 12 of the electronic hard tag 1. The product side 12 is the side of the electronic hard tag 1, which is configured to contact the product 7, when the electronic hard tag 1 is applied to the product 7. The product 7 may comprise the product 7 itself and/or a corresponding packaging 11 of the product 7.

The product side of the housing 2 and the product side of the RFID cover 2a are arranged coplanar fashion with respect to each other. On other words, the product side of the housing 2 and the product side of the RFID cover 2a are arranged on one single virtual plane (best visible in FIG. 2).

The housing 2 comprising the cavity 9 and the RFID cover 2a provide an advantageous protected position for the radio frequency identification circuit 3.

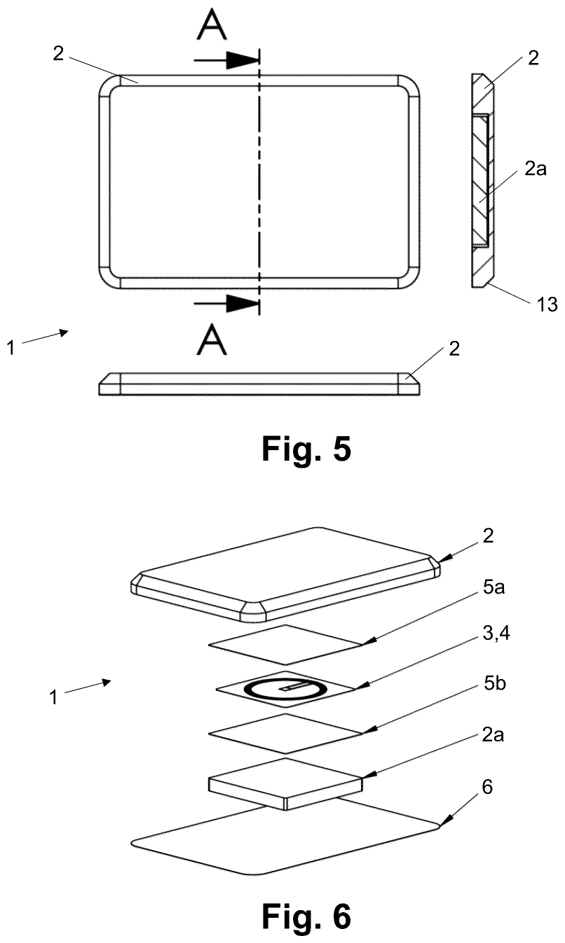

The FIGS. 5 and 6 show a second embodiment of the electronic hard tag 1. The electronic hard tag 1 comprises the same components as presented with respect to the first embodiment. The second embodiment differs in the shape, in the outer contour, of the different parts. As best visible in FIG. 5, which shows a top view, a side view and a cross section, the second embodiment of the electronic hard tag 1 has the shape or the outer contour of a cuboid comprising a chamfer 13. The housing 2 has the shape of a cuboid, the cavity 9 of the housing 2 has the shape of a cuboid and the RFID cover 2a has the shape of a cuboid. The radio frequency identification circuit 3 has a rectangular shape and the first and second circuit adhesive layer 5a, 5b and the product adhesion layer 6 have a rectangular shape.

In other embodiments, the electronic hard tag 1 has different shapes. It as, for example, an elliptical shape or a combination of different shapes.

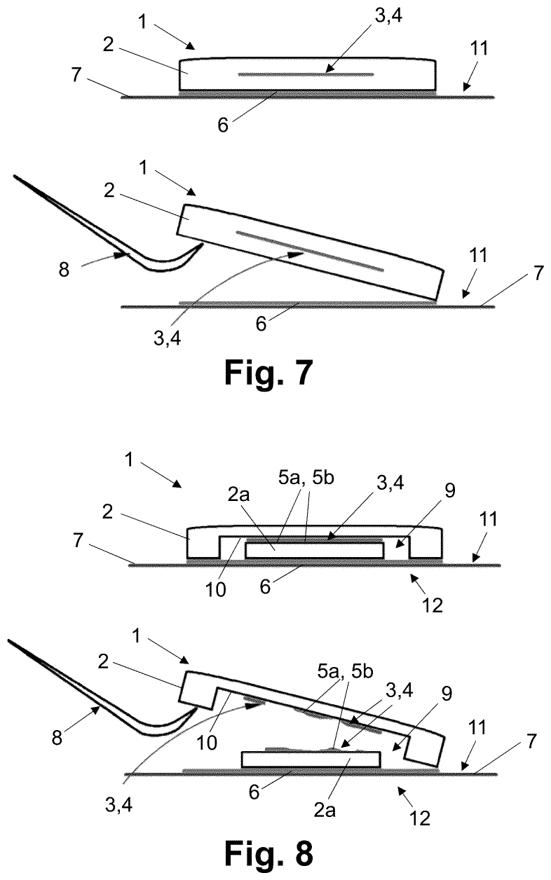

FIG. 7 shows a conventional electronic hard tag 1 with a solid housing 2, which completely encloses the radio frequency identification circuit 3 comprising the antenna 4. FIG. 7 further shows a product adhesion layer 6, which attaches the conventional electronic hard tag 1 to the product 7 or the packaging 11 of the product. The lower part of FIG. 7 further shows an attempted removal of the conventional electronic hard tag 1 from the product 7. A lever 8 engages with the housing 2 and thereby removes the entire electronic hard tag 1 from the product. The electronic hard tag 1 and in particular the radio frequency identification circuit 3 remain readable even if the conventional electronic hard tag 1 is successfully removed from the product 7, in particular because the housing 2 protects the electronics inside even during a harsh removal.

FIG. 8 shows on the top portion a cross section of the electronic hard tag 1 according to the first or second embodiment of the present disclosure and on the bottom an attempted removal of the electronic hard tag 1. FIG. 8 shows the housing 2 with the cavity 9 and the radio frequency identification circuit 3 with the antenna 4 arranged in the cavity 9. Further, FIG. 8 shows the RFID cover 2a arranged between the radio frequency identification circuit 3 and the product 7. In addition, the product adhesive layer 6 and the first circuit adhesive layer 5a and the second circuit adhesive layer 5b are indicated in FIG. 8. The lower portion of FIG. 8 shows an attempted removal of the electronic hard tag 1 from the product 7. A lever 8 is for example placed between the housing 2 and the product to lever the electronic hard tag 1 off the product 7. By removing the housing 2, shear forces are applied via the first and second circuit adhesive layers 5a, 5b to the radio frequency identification circuit 3, in particular to the antenna 4, the shear forces destroy/tear apart the radio frequency identification circuit 3, which makes the radio frequency identification circuit 3 unreadable. FIG. 8 indicates this in that some parts of the radio frequency identification circuit 3 are still arranged on the removed housing 2 and other parts of the radio frequency identification circuit 3 remain (after the removal) on the RFID cover 2a.

The figures also show that an electronic hard tag 1, when applied to a product 7, does not differ visually/optically from a conventional electronic hard tag as for example shown in FIG. 7, which makes it advantageously difficult for a potential scammer to remove the electronic hard tag 1 according to the present disclosure from the product 7 without destroying the radio frequency identification circuit 3.

In one embodiment, the radio frequency identification circuit 3 is a passive radio frequency identification circuit 3 without a power source. In another embodiment, the radio frequency identification circuit 3 is an active radio frequency identification circuit 3 comprising its own power source, for example a battery.

In a further embodiment, the radio frequency identification circuit 3 may comprise a near field communication (NFC) circuit, a low frequency (LF) communication circuit, a ultra high frequency (UHF) communication circuit, a combination thereof and/or any other kind of RFID communication circuit.

### LIST OF REFERENCE SYMBOLS

1 electronic hard tag, RFID tag
2 housing
2a RFID cover
3 radio frequency identification circuit
4 antenna
5a first circuit adhesion layer
5b second circuit adhesion layer
6 product adhesion layer
7 product, consumer product
8 lever
9 cavity/depression
10 cavity bottom
11 packaging
12 product side
13 chamfer/rounding

1. Electronic hard tag for application on a product the electronic hard tag comprising a radio frequency identification circuit and a housing, wherein the electronic hard tag further comprises:
a first circuit adhesion layer, arranged between the housing and the radio frequency identification circuit, and configured to attach the radio frequency identification circuit to the housing; and
a product adhesion layer, arranged on a product side of the housing and on the frequency identification circuit, and configured to attach the housing and the radio frequency identification circuit to the product.

2. The electronic hard tag according to claim 1, further comprising:
a RFID cover, arranged between the product adhesion layer and the radio frequency identification circuit, wherein the product adhesion layer is further configured to attach the RFID cover to the product; and
a second circuit adhesion layer, arranged between the RFID cover and the radio frequency identification circuit, and configured to attach the radio frequency identification circuit to the RFID cover.

3. The electronic hard tag according to claim 1, wherein the radio frequency identification circuit comprises an antenna, which is at least partially attached via the first circuit adhesion layer to the housing, wherein the antenna is further configured to be at least partially attached to the product via the product adhesion layer, or wherein the antenna is at least partially attached via the second circuit adhesion layer to the RFID cover.

4. The electronic hard tag according to claim 1, wherein the housing has a cylindrical outer shape and comprises a cavity, which extends from the product side of the housing into the housing until a cavity bottom, and wherein the first circuit adhesion layer attaches the radio frequency identification circuit to the cavity bottom.

5. The electronic hard tag according to claim 4, wherein the housing has an outer circular cylindrical shape, and wherein the cavity has a circular cylindrical shape and extends coaxially with respect to circular cylindrical shape of the housing.

6. The electronic hard tag according to claim 3, wherein the RFID cover has a cylindrical shape and is arranged within the cavity of the housing, and wherein the product axial end of the RFID cover is attached to the product adhesion layer, and wherein the second circuit adhesion layer attaches the radio frequency identification circuit to the axial end of the RFID cover arranged opposite with respect to the product axial end.

7. The electronic hard tag according to claim 6, wherein the RFID cover has an outer circular cylindrical shape, and wherein the RFID cover is arranged coaxially with respect to the housing.

8. The electronic hard tag according to claim 6, wherein the outer contour of the radio frequency identification circuit corresponds to the shape of the axial end of the RFID cover opposite to the product axial end.

9. The electronic hard tag according to claim 6, wherein the product axial end of the housing and the product axial end of the RFID cover are arranged coplanar with respect to each other, thereby forming a plane surface onto which the product adhesion layer is attached.

10. The electronic hard tag according to claim 9, wherein the product adhesion layer extends from the outer edge of the product axial end of the housing until the center point of the product axial end of the RFID cover.

11. The electronic hard tag according to claim 9, wherein the product adhesion layer comprises a first portion, which is arranged on the housing, and a second portion, which is arranged on the RFID cover, thereby leaving a gap between the first portion on the housing and the second portion on the RFID cover.

12. The electronic hard tag according to claim 2, wherein the product adhesion layer is configured such that an attempted removal of the housing from the product, onto which the electronic hard tag is attached, results in a separation of the housing from the product adhesion layer and wherein at least one of the first or second circuit adhesion layer is configured such that the attempted removal of the housing from the product results in a destruction of the radio frequency identification circuit.

13. The electronic hard tag according to claim 12, wherein the first circuit adhesion layer is arranged only partially between the housing and the radio frequency identification circuit and/or wherein the product adhesion layer is arranged only partially between the product and the radio frequency identification circuit or wherein the second circuit adhesion layer is arranged only partially between the radio frequency identification circuit and the RFID cover.

14. The electronic hard tag according to claim 1, wherein the housing or the RFID cover comprise(s) at least one of: polyphenylene sulfide (PPS), acrylonitrile butadiene styrene (ABS), poly amid.

15. The electronic hard tag according to claim 2, wherein product adhesion layer, the first circuit adhesion layer and/or the second circuit adhesion layer comprises an acrylic adhesive.

16. A packaging for a consumer product comprising the electronic hard tag according to claim 1.

17. A product comprising an electronic hard tag according to claim 1.
